(19) United States
(12) Patent Application Publication
(10) Pub. No.: US 2025/0325141 A1
(43) Pub. Date: Oct. 23, 2025

(54) AIR HEATING COOKER

(71) Applicant: Tsann Kuen (Zhangzhou) Enterprise Co., Ltd., Zhangzhou City (CN)

(72) Inventors: Yixin Zhan, Zhangzhou City (CN); Bo Wei, Zhangzhou City (CN)

(21) Appl. No.: 19/012,995

(22) Filed: Jan. 8, 2025

(30) Foreign Application Priority Data
Apr. 19, 2024 (CN) 202420826482.5

(51) Int. Cl. A47J 37/06

(52) U.S. Cl. CPC A47J 37/0641

(57) ABSTRACT

The disclosure provides an air heating cooker, including a main body and an oven door panel. A casing of the main body is provided with an accommodating space. The accommodating space has an accommodating opening on a same side as a cooking chamber opening. The oven door panel is slidably assembled in the accommodating space. The oven door panel, when in a second position of being drawn out of the accommodating space, is hinged with the casing and is flippable to cover the cooking chamber opening. When the oven door panel is not needed, the oven door panel is stored in the accommodating space.

### CROSS-REFERENCE TO RELATED APPLICATIONS

This application claims priority to Chinese Patent Application 202420826482.5, filed on Apr. 19, 2024, which is incorporated herein by reference.

### TECHNICAL FIELD

The disclosure relates to the field of cooking utensils, and in particular to an air heating cooker.

### BACKGROUND

An air heating cooker is a cooker that uses hot air to cook food, such as an air fryer oven or an air fryer. The air fryer oven is an air heating cooker provided with an oven door panel at the cooking chamber opening, and it functions as an oven by closing or opening the oven door panel. However, if the air fryer oven does not function as an oven (for example, needs to switch to an air fryer), the oven door panel will become an unnecessary structure, making it inconvenient to use. In this case, the oven door panel will often be removed. In this way, the repeated removal and mounting of the oven door panel easily causes wear of the connecting structure; and the oven door panel needs to be stored separately after being removed, making it lost easily.

### SUMMARY

In view of this, in order to solve the above problem, the disclosure provides an air heating cooker.

In order to achieve the above objective, the disclosure provides the following technical solution:

An air heating cooker includes a main body and an oven door panel. The main body includes a casing and a hot air component. The casing has a cooking chamber and a cooking chamber opening in communication with the cooking chamber, and the hot air component is assembled in the casing to deliver hot air to the cooking chamber. The casing of the main body is further provided with an accommodating space. The accommodating space has an accommodating opening on a same side as the cooking chamber opening. The oven door panel is slidably assembled in the accommodating space so as to switch between a first position of being stored in the accommodating space and a second position of being drawn out of the accommodating space, and the oven door panel, when in the second position, is hinged with the casing and is flippable to cover the cooking chamber opening.

Further, the accommodating space is located at a bottom of the casing.

Further, opposite side walls of the accommodating space are each provided with a guide slotted hole, two sides of the oven door panel are each provided with a convex column, and the convex column is fitted in the guide slotted hole such that the oven door panel is slidably assembled in the accommodating space.

Further, a cross section of the convex column has at least a first diameter of a minimum size and a second diameter of a maximum size, a width of the guide slotted hole is matched with the first diameter of the convex column, and when the oven door panel is parallel to an extending direction of the guide slotted hole, the first diameter of the convex column is parallel to a width direction of the guide slotted hole and slidably fitted in the guide slotted hole. An end of the guide slotted hole facing the accommodating opening is connected with a hinging slotted hole, and a hole diameter of the hinging slotted hole is matched with the second diameter of the convex column. When the oven door panel is in the second position, the convex column is fitted in the hinging slotted hole such that the oven door panel is hinged.

Further, the cross section of the convex column is D-shaped or square.

Further, tension springs are further arranged in the accommodating space, a first end of each of the tension springs is connected to the oven door panel, a second end is connected to the casing, and each of the tension springs applies a pulling force to the oven door panel in a direction away from the accommodating opening.

Further, opposite side walls of the accommodating space are each provided with a guide slotted hole, two sides of the oven door panel are each provided with a convex column, and the convex column is fitted in the guide slotted hole such that the oven door panel is slidably assembled in the accommodating space. A first end of each of the tension springs is connected to the convex column, and a second end is connected to the casing.

Further, the casing is provided with an elastic pin at the cooking chamber opening, the oven door panel is provided with a first fixing slot and a first inclined guide surface arranged corresponding to the first fixing slot, and when the oven door panel is flipped to cover the cooking chamber opening, the elastic pin snaps into the first fixing slot of the oven door panel under cooperation of the first inclined guide surface so as to be fixed.

Further, the first fixing slot of the oven door panel is a V-shaped slot and has a guide slot wall facing away from the first inclined guide surface, and when the oven door panel is opened, the elastic pin is separated from the first fixing slot under cooperation of the guide slot wall.

Further, the oven door panel is provided with a handle.

Further, opposite vertical side walls of the cooking chamber are each provided with a plurality of insertion slots. The air heating cooker further includes oven racks and a residue tray, and the oven racks and the residue tray are insertable into or separable from the insertion slots of the cooking chamber via the cooking chamber opening.

Further, the air heating cooker further includes a frying basket, and when the oven door panel is in the first position of being stored, the frying basket is insertable into or separable from the cooking chamber via the cooking chamber opening.

The technical solution provided by the disclosure has the following beneficial effects:

The casing of the main body is provided with the accommodating space, and the oven door panel is slidably assembled in the accommodating space. When the oven door panel is needed, the oven door panel is drawn out to the second position, and then flipped cover the cooking chamber opening. When the oven door panel is not needed, the oven door panel is stored in the accommodating space. There is no need to remove and mount the oven door panel, and the oven door panel is stored in the casing of the main body, so that the oven door panel can be stored in an integrated structure and will not be lost.

### BRIEF DESCRIPTION OF DRAWINGS

FIG. 1 is a schematic three-dimensional view of an air heating cooker when functioning as an air fryer oven according to an example, where an oven door panel does not completely cover a cooking chamber opening;

FIG. 2 is a top view of the structure shown in FIG. 1;

FIG. 3 is a sectional view taken along line A-A in FIG. 2;

FIG. 4 is a sectional view taken along line B-B in FIG. 2;

FIG. 5 is a sectional view taken along line C-C in FIG. 2;

FIG. 6 is a schematic structural view of a casing of a main body of the air heating cooker according to an example;

FIG. 7 is a schematic structural view I of the air heating cooker according to an example, where the oven door panel is in a first position;

FIG. 8 is a sectional view of the structure shown in FIG. 7;

FIG. 9 is a sectional view of the air heating cooker when the oven door panel is in the second position according to an example;

FIG. 10 is a schematic enlarged view of D in FIG. 9;

FIG. 11 is a sectional view of the air heating cooker when the oven door panel does not completely cover the cooking chamber opening according to an example;

FIG. 12 is a schematic enlarged view of E in FIG. 11;

FIG. 13 is a sectional view of the air heating cooker when the oven door panel completely covers the cooking chamber opening according to an example;

FIG. 14 is a schematic enlarged view of F in FIG. 13;

FIG. 15 is a schematic three-dimensional view I of the air heating cooker when functioning as an air fryer according to an example; and

FIG. 16 is a schematic three-dimensional view II of the air heating cooker when functioning as an air fryer according to an example.

### DESCRIPTION OF EMBODIMENTS

To further illustrate the examples, the accompanying drawings are provided in the disclosure. These accompanying drawings are a part of the contents disclosed in the disclosure that are mainly used to illustrate the examples, and can be used in conjunction with the related descriptions in the specification to explain the operation principle of the examples. With reference to these contents, those of ordinary skill in the art should be able to understand other possible embodiments and advantages of the disclosure. Components in the drawings are not drawn to scale, and like component symbols are usually used to represent like components.

In the description of the disclosure, the orientation or positional relationship indicated by the term “upper”, “lower”, “left”, “right”, “front”, “rear” or the like is based on the orientation or positional relationship shown in the accompanying drawings. This is only for the convenience of describing the disclosure and simplifying the description, and does not indicate or imply that the device or element must have a specific orientation, or be constructed and operated in a specific orientation, and therefore cannot be understood as a limitation of the disclosure.

The disclosure will be further described in conjunction with the accompanying drawings and specific embodiments.

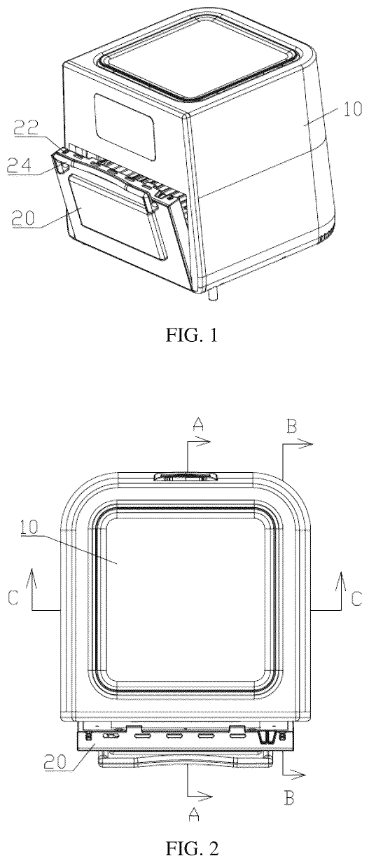

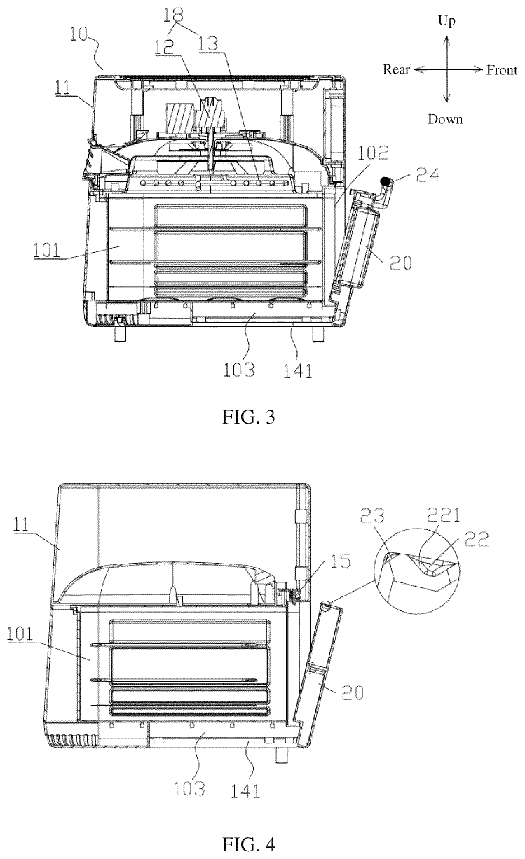

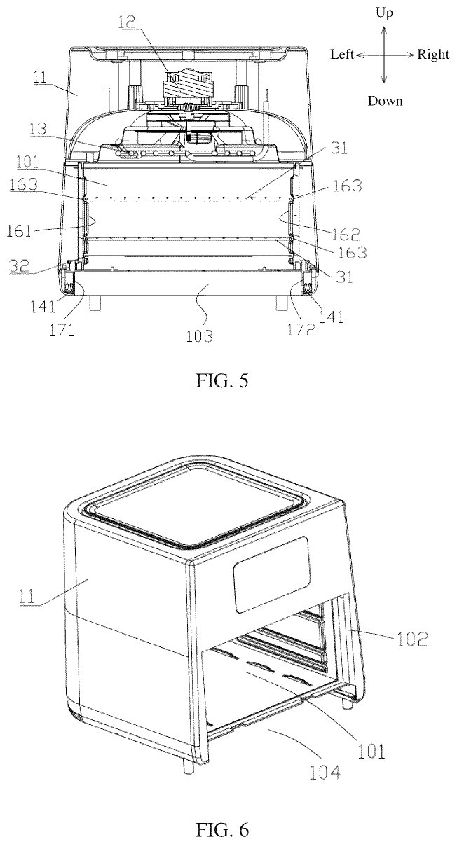

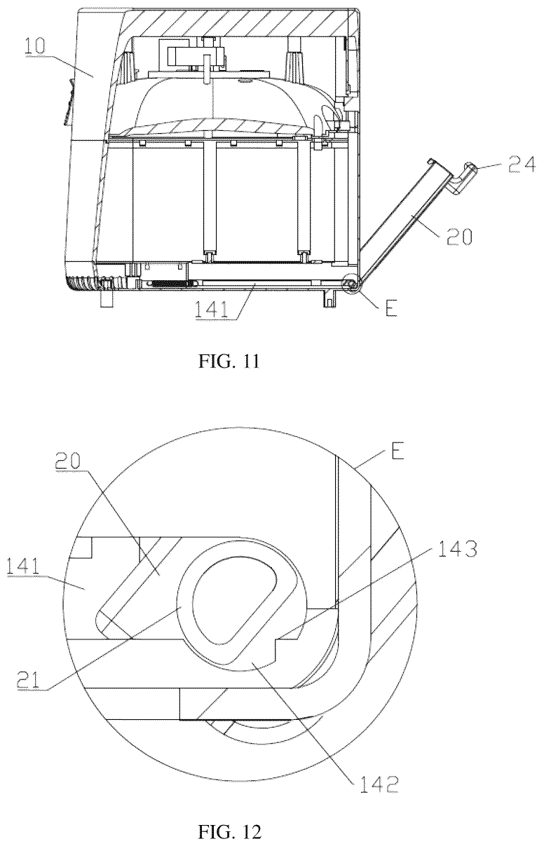

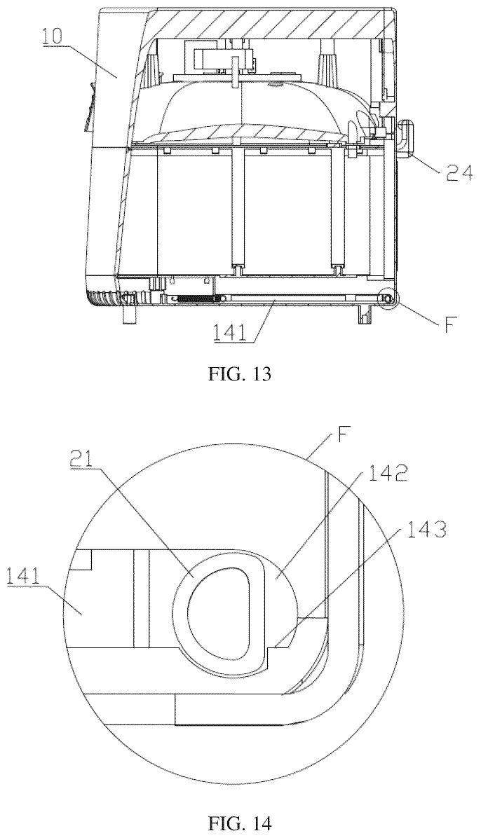

As shown in FIG. 1 to FIG. 14, this example provides an air heating cooker, including a main body 10 and an oven door panel 20. The main body 10 includes a casing 11 and a hot air component 18. The casing 11 has a cooking chamber 101 and a cooking chamber opening 102 in communication with the cooking chamber 101, and the hot air component 18 is assembled in the casing 11 to deliver hot air to the cooking chamber 101. Specifically, in this example, the hot air component 18 is located above the cooking chamber 101, the hot air component 18 includes a fan 12 and a heating tube 13, and the heating tube 13 is located below the fan 12. The fan 12 delivers air flows downward to the heating tube 13, and the air flows are heated by the heating tube 13 to form hot air that flows downward into the cooking chamber 101.

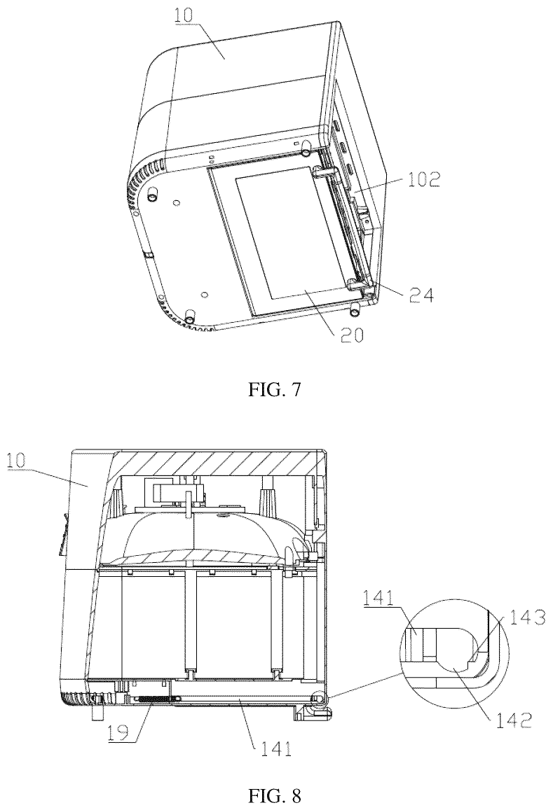

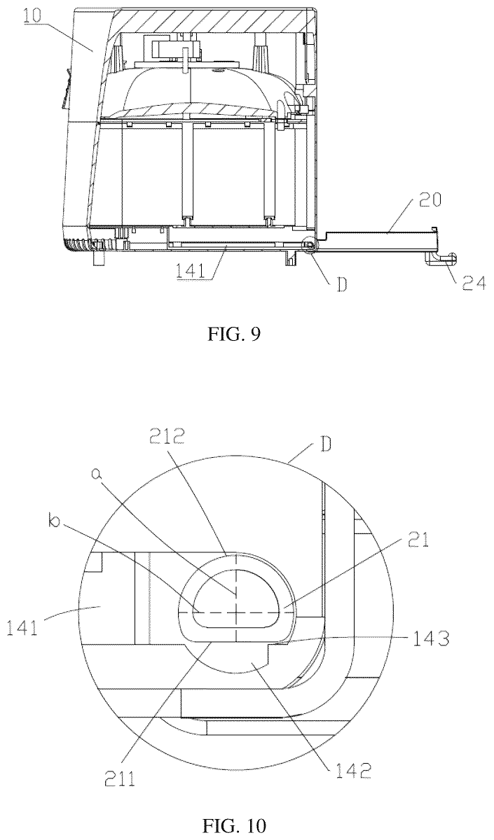

The casing 11 of the main body 10 is further provided with an accommodating space 103. The accommodating space 103 has an accommodating opening 104 on a same side as the cooking chamber opening 102. Specifically, the accommodating space 103 is located at a bottom of the casing 11 of the main body 10. In addition to having the accommodating opening 104 on the same side as the cooking chamber opening 102, a bottom of the accommodating space 103 is hollowed, which is equivalent to providing a groove structure at the bottom of the casing 11. Of course, in other examples, the bottom of the accommodating space 103 may also be not hollowed. The oven door panel 20 is slidably assembled in the accommodating space 103 so as to switch between a first position of being stored in the accommodating space 103 (as shown in FIG. 7 and FIG. 8) and a second position of being drawn out of the accommodating space 103 (as shown in FIG. 9). Specifically, when in the second position, as shown in FIG. 9, the oven door panel 20 is parallel to the sliding direction. The oven door panel 20, when in the second position, is hinged with the casing 11 and is flippable to cover the cooking chamber opening 102. As shown in FIG. 9 to FIG. 14, when the oven door panel 20 is in the second position, the oven door panel 20 is flipped upward by 90° to cover the cooking chamber opening 102.

According to the structure of the air heating cooker designed in this example, when the oven door panel 20 is needed, the oven door panel 20 is drawn out from the first position to the second position. The oven door panel 20, when in the second position, is in a hinged state and is flippable. Thereby, the oven door panel 20 can be flipped upward to cover the cooking chamber opening 102, so that the air heating cooker can function as an air fryer oven. When the oven door panel 20 is not needed, the oven door panel 20 is flipped from the position of covering the cooking chamber opening 102 downward to the second position, and then, the oven door panel 20 is pushed into the accommodating space 103. There is no need to remove and mount the oven door panel 20, and the oven door panel 20 is stored in the casing 11 of the main body 10, so that the oven door panel can be stored in an integrated structure and will not be lost.

Specifically, the accommodating space 103 is arranged at the bottom of the casing 11 of the main body 10, i.e., below the cooking chamber 101, which will not affect the assembly of other parts nor additionally increase the width of the product, thus being one of the preferred solutions. Of course, in other examples, the accommodating space 103 may also be arranged above or on the left or right side of the cooking chamber 101.

Specifically, opposite side walls of the accommodating space 103 (i.e., a left side wall 171 and a right side wall 172 of the accommodating space 103) are each provided with a guide slotted hole 141. Specifically, the guide slotted hole 141 is an elongated slotted hole extending along a front-rear direction. Two sides of the oven door panel 20 are each provided with a convex column 21. Specifically, left and right sides of the oven door panel 20 are each provided with a convex column 21. The convex column 21 is fitted in the guide slotted hole 141 such that the oven door panel 20 is slidably assembled in the accommodating space 103. In this way, the structure is simple in design and easy to realize.

Further, a cross section of the convex column 21 has at least a first diameter of a minimum size and a second diameter of a maximum size, i.e., the cross section of the convex column 21 is non-circular. In this specific example, the cross section of the convex column 21 is D-shaped, as shown in FIG. 10, i.e., the cross section of the convex column 21 has a structure formed by a straight segment 211 and an arc segment 212, which is equivalent to a figure obtained by cutting a part off a circle and chamfering the connecting ends. Line a where the first diameter of the cross section of the convex column 21 is located is perpendicular to the straight segment 211, and Line b where the second diameter is located is parallel to the straight segment 211.

A width of the guide slotted hole 141 is matched with the first diameter of the convex column 21, and when the oven door panel 20 is parallel to an extending direction of the guide slotted hole 141, the first diameter of the convex column 21 is parallel to a width direction of the guide slotted hole 141 and slidably fitted in the guide slotted hole 141. An end of the guide slotted hole 141 facing the accommodating opening 104 is connected with a hinging slotted hole 142, and a hole diameter of the hinging slotted hole 142 is matched with the second diameter of the convex column 21. When the oven door panel 20 is in the second position, the convex column 21 is fitted in the hinging slotted hole 142 such that the oven door panel 20 is hinged. Thereby, when the oven door panel 20 is in the first position or in any position between the first position and the second position, the convex column 21 cannot rotate due to the limitation of the guide slotted hole 141, so the state of the oven door panel 20 can be kept without additional limiting structures for limiting. When the oven door panel 20 reaches the second position, the convex column 21 enters the hinging slotted hole 142, and the convex column 21 in this position can rotate, so that the limit to the rotation of the oven door panel 20 is removed and the oven door panel is freely flippable between the second position and the position of covering the cooking chamber opening 102.

Further, the oven door panel 20 flips only within the range between the second position and the position of covering the cooking chamber opening 102. Therefore, on the premise of not affecting the flip of the oven door panel 20, the hinging slotted hole 142 is further provided with an abutting step 143. The abutting step 143 is located on the opposite side of the guide slotted hole 141, i.e., the abutting step 143 and the guide slotted hole 141 are distributed on the front and rear sides of the hinging slotted hole 142. With the arrangement of the abutting step 143, when the oven door panel 20 switches from the position of covering the cooking chamber opening 102 to the second position, the convex column 21 can be abutted and limited by the abutting step 143, so that the oven door panel 20 is accurately limited to the second position and can be directly pushed into the accommodating space 103 when it needs to be stored, which makes the storage operation smoother and faster.

Specifically, the use of the convex column 21 having a D-shaped cross section and specific fitting structures is a preferred embodiment of this application. Of course, in other examples, the cross section of the convex column 21 may also be square or in other non-circular shapes such as polygons or an ellipse, as long as the fit between the convex column 21 and the guide slotted hole 141 can limit the flip of the oven door panel 20. Alternatively, the cross section of the convex column 21 may also be circular, and in this case, the convex column 21 can rotate in the guide slotted hole 141 without the additional hinging slotted hole 142, which is not limited. However, the oven door panel 20 needs to be provided with additional limiting structures, so that it can be kept in the stored state when stored in the accommodating space 103.

Tension springs 19 are further arranged in the accommodating space 103, a first end of each of the tension springs 19 is connected to the oven door panel 20, and specifically, to the convex column 21 of the oven door panel 20, a second end is connected to the casing 11, and each of the tension springs 19 applies a pulling force to the oven door panel 20 in a direction away from the accommodating opening 104, i.e., the tension spring 19 applies a pulling force that makes the oven door panel 20 stored into the accommodating space 103. In this way, when the oven door panel 20 is in the second position, as long as a slight external force is applied to push the oven door panel 20, the oven door panel 20 can be stored into the accommodating space 103 under the actions of the applied external force and the pulling force of the tension spring 19; or in a case where the pulling force of the tension spring 19 is strong enough, as long as the oven door panel 20 reaches the second position, it can be stored into the accommodating space 103 under the action of the pulling force of the tension spring 19, which makes the storage operation more labor-saving. Similarly, when the oven door panel 20 needs to be drawn out, it is required to apply a larger external force to overcome the pulling force of the tension spring 19 to pull the oven door panel 20.

The casing 11 is provided with an elastic pin 15 at the cooking chamber opening 102, the oven door panel 20 is provided with a first fixing slot 22 and a first inclined guide surface 23 arranged corresponding to the first fixing slot 22, and when the oven door panel 20 is flipped to cover the cooking chamber opening 102, the elastic pin 15 snaps into the first fixing slot 22 of the oven door panel 20 under cooperation of the first inclined guide surface 23 so as to be fixed. In this way, the oven door panel 20 covers the cooking chamber opening without additional operations.

Similarly, the first fixing slot 22 of the oven door panel 20 is a V-shaped slot and has a guide slot wall 221 facing away from the first inclined guide surface 23. When the oven door panel 20 needs to be opened, as long as a force that makes the oven door panel 20 open outward is applied, the elastic pin 15 is separated from the first fixing slot 22 under the cooperation of the guide slot wall 221, thereby realizing unlocking without additional unlocking operations.

The oven door panel 20 is provided with a handle 24, which is convenient for holding and force application.

Opposite vertical side walls of the cooking chamber 101 (a left side wall 161 and a right side wall 162 of the cooking chamber 101) are each provided with a plurality of insertion slots 163. The air heating cooker further includes oven racks 31 and a residue tray 32, and the oven racks 31 and the residue tray 32 are insertable into or separable from the insertion slots 163 of the cooking chamber 101 via the cooking chamber opening 102. The addition of the insertion slots 163 that can fix the oven racks 31 and the residue tray 32 facilitates the mounting of the oven racks 31 and the residue tray 32, so that food can be placed in a better way. Of course, in other examples, the oven racks 31 and the residue tray 32 may not be used.

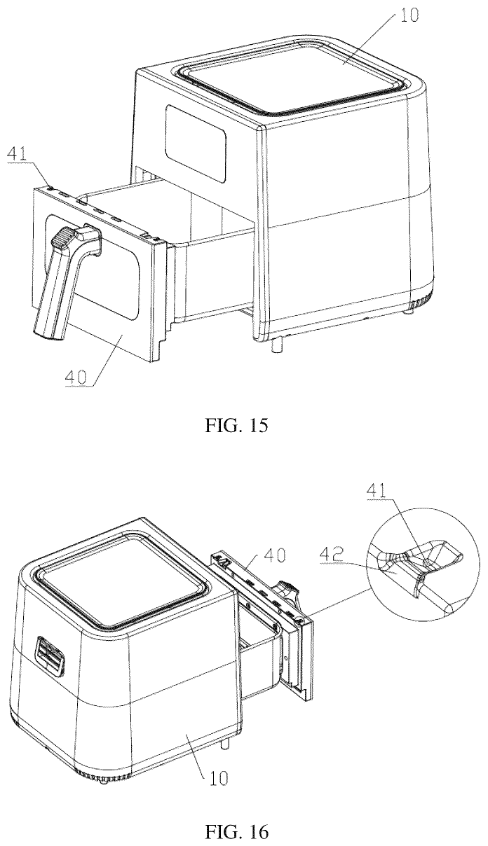

Further, as shown in FIG. 15 and FIG. 16, in this example, the air heating cooker further includes a frying basket 40, and when the oven door panel 20 is in the first position of being stored, i.e., when the oven door panel 20 is not used, the frying basket 40 is insertable into or separable from the cooking chamber 101 via the cooking chamber opening 102, so that the air heating cooker can function as an air fryer. The air heating cooker can switch between functioning as an air fryer oven and as an air fryer, and can be used for two purposes.

Further, the frying basket 40 is provided with a second fixing slot 41 and a second inclined guide surface 42 arranged corresponding to the second fixing slot 41. When the frying basket 40 is pushed into the cooking chamber 101 and in place, the elastic pin 15 snaps into the second fixing slot 41 of the frying basket 40 under cooperation of the second inclined guide surface 42 so as to be fixed. Specifically, the second fixing slot 41 has a same structure as the first fixing slot 22, both being V-shaped slots. In this way, when the frying basket 40 needs to be drawn out, as long as an outward force is applied to the frying basket 40, the elastic pin 15 can be separated from the second fixing slot 41, thereby realizing unlocking without additional unlocking operations.

Specifically, when the air heating cooker is not in use or when it is packaged in the factory, for the purpose of space saving, the oven door panel 20 may be stored in the accommodating space 103 of the casing 11 of the main body 10, and then, the frying basket 40 may be inserted into the cooking chamber 101, so that the air heating cooker can be stored and packaged in small size.

Although the disclosure has been specifically shown and described in connection with the preferred embodiments, it should be understood by those skilled in the art that various changes in form and details can be made without departing from the spirit and scope of the disclosure as defined by the appended claims, and shall all fall within the protection scope of the disclosure.

1. An air heating cooker, comprising a main body and an oven door panel, wherein the main body comprises a casing and a hot air component, the casing has a cooking chamber and a cooking chamber opening in communication with the cooking chamber, the hot air component is assembled in the casing to deliver hot air to the cooking chamber, the casing of the main body is further provided with an accommodating space, the accommodating space has an accommodating opening on a same side as the cooking chamber opening, the oven door panel is slidably assembled in the accommodating space so as to switch between a first position of being stored in the accommodating space and a second position of being drawn out of the accommodating space, and the oven door panel, when in the second position, is hinged with the casing and is flippable to cover the cooking chamber opening.

2. The air heating cooker according to claim 1, wherein the accommodating space is located at a bottom of the casing.

3. The air heating cooker according to claim 1, wherein opposite side walls of the accommodating space are each provided with a guide slotted hole, two sides of the oven door panel are each provided with a convex column, and the convex column is fitted in the guide slotted hole such that the oven door panel is slidably assembled in the accommodating space.

4. The air heating cooker according to claim 3, wherein a cross section of the convex column has at least a first diameter of a minimum size and a second diameter of a maximum size, a width of the guide slotted hole is matched with the first diameter of the convex column, when the oven door panel is parallel to an extending direction of the guide slotted hole, the first diameter of the convex column is parallel to a width direction of the guide slotted hole and slidably fitted in the guide slotted hole, an end of the guide slotted hole facing the accommodating opening is connected with a hinging slotted hole, a hole diameter of the hinging slotted hole is matched with the second diameter of the convex column, and when the oven door panel is in the second position, the convex column is fitted in the hinging slotted hole such that the oven door panel is hinged.

5. The air heating cooker according to claim 4, wherein the cross section of the convex column is D-shaped or square.

6. The air heating cooker according to claim 1, wherein tension springs are further arranged in the accommodating space, a first end of each of the tension springs is connected to the oven door panel, a second end of each of the tension springs is connected to the casing, and each of the tension springs applies a pulling force to the oven door panel in a direction away from the accommodating opening.

7. The air heating cooker according to claim 6, wherein opposite side walls of the accommodating space are each provided with a guide slotted hole, two sides of the oven door panel are each provided with a convex column, the convex column is fitted in the guide slotted hole such that the oven door panel is slidably assembled in the accommodating space, the first end of each of the tension springs is connected to the convex column, and the second end of each of the tension springs is connected to the casing.

8. The air heating cooker according to claim 1, wherein the casing is provided with an elastic pin at the cooking chamber opening, the oven door panel is provided with a first fixing slot and a first inclined guide surface arranged corresponding to the first fixing slot, and when the oven door panel is flipped to cover the cooking chamber opening, the elastic pin snaps into the first fixing slot of the oven door panel under cooperation of the first inclined guide surface so as to be fixed.

9. The air heating cooker according to claim 1, wherein opposite vertical side walls of the cooking chamber are each provided with a plurality of insertion slots, the air heating cooker further comprises oven racks and a residue tray, and the oven racks and the residue tray are insertable into or separable from the plurality of insertion slots of the cooking chamber via the cooking chamber opening.

10. The air heating cooker according to claim 1, wherein the air heating cooker further comprises a frying basket, and when the oven door panel is in the first position of being stored, the frying basket is insertable into or separable from the cooking chamber via the cooking chamber opening.
